(19) United States
(12) Patent Application Publication
(10) Pub. No.: US 2022/0128953 A1
(43) Pub. Date: Apr. 28, 2022

(54) SENSOR DEVICE AND WEARABLE DEVICE

(71) Applicant: TOSHIBA TEC KABUSHIKI KAISHA, Tokyo (JP)

(72) Inventors: Sadatoshi OISHI, Fuji Shizuoka (JP); Kento KAWATA, Fujisawa Kanagawa (JP); Yuki KAWASAKI, Numazu Shizuoka (JP); Sunao TSUCHIDA, Mishima Shizuoka (JP); Hiroyuki ISHIKAWA, Sunto Shizuoka (JP); Masakazu KATO, Numazu Shizuoka (JP)

(21) Appl. No.: 17/366,806

(22) Filed: Jul. 2, 2021

(30) Foreign Application Priority Data
Oct. 23, 2020 (JP) 2020-177777

(51) Int. Cl. G04G 21/04; G06F 1/16; G06K 7/10; G04G 9/00

(52) U.S. Cl. CPC G04G 21/04; G04G 9/007; G06K 7/10297; G06F 1/163

(57) ABSTRACT

According to one embodiment, a sensor device to be used with a wearable electronic device including a smart terminal device and a band that enables the smart terminal to be worn on a forearm of a user has a first end portion that is nearer the hand of the user when worn on the forearm of the user, a second end portion that is nearer the elbow of the user when worn, and an attachment portion that is configured to connect the sensor to the band. The attachment portion is offset from a midpoint between the first end portion and the second end portion along a direction along the forearm from the elbow to the hand towards the first end portion.

### CROSS-REFERENCE TO RELATED APPLICATION

This application is based upon and claims the benefit of priority from Japanese Patent Application No. 2020-177777, filed Oct. 23, 2020, the entire contents of which are incorporated herein by reference.

### FIELD

Embodiments of the present disclosure relate to a sensor device and a wearable electronic device incorporating a sensor.

### BACKGROUND

As a kind of a wearable electronic device, there is a wristwatch-type device that is worn on a forearm. The wristwatch-type device comprises a smart terminal device and a band enabling the smart terminal device to be held on the forearm of a user. An example of a smart terminal device is a smart watch. In addition to a date and time display function, the smart watch may have various functions such as a health tracking function, an incoming call notification function, a voice calling function, an information communication function, and a music playing function.

With such a wearable electronic device, there is a general demand for increased functionality such that, for example, the wearable smart device may also incorporate functions of various sensor devices that a smart device does not typically provide. However, it is naturally desired that overall usability of the smart device is not impaired.

### BRIEF DESCRIPTION OF THE DRAWINGS

FIG. 1 is a perspective view illustrating aspects of a wearable device according to an embodiment.

FIG. 2 is another perspective view illustrating aspects of a wearable device according to an embodiment.

FIG. 3 depicts a change in a display screen on a display unit of a wearable device according to an embodiment.

FIG. 4 is a diagram illustrating an example of a wearable device according to an embodiment being worn by a user. The user is depicted with the hand being stretched outward (straight position).

FIG. 5 is a diagram illustrating an example of a wearable device according to an embodiment being worn by a user. The user is depicted with the hand being bent downward (bent position).

FIG. 6 is a diagram illustrating an example of a wearable device of a comparative example being worn by a user. The user is depicted with the hand being stretched outward (straight position).

FIG. 7 is a diagram illustrating an example of a wearable device of a comparative example being worn by a user. The user is depicted with the hand being bent downward (bent position).

### DETAILED DESCRIPTION

According to one embodiment, a sensor device for a wearable electronic device that includes a smart terminal device and a band that enables the smart terminal device to be worn on a forearm of a user is provided. The sensor device has a first end portion that is nearer the hand of the user when the wearable electronic device is worn on the forearm of the user and a second end portion that is nearer the elbow of the user when the wearable electronic device is worn on the forearm of the user. The sensor device has an attachment portion that is configured to connect to the band. The attachment portion is positioned so as to be offset from a midpoint between the first end portion and the second end portion along a direction along the forearm from the elbow to the hand towards the first end portion.

Hereinafter, certain example embodiments will be described with reference to the drawings. In the drawings, similar components are denoted by the same reference numerals. The drawings are schematic and conceptual and are not necessarily to scale.

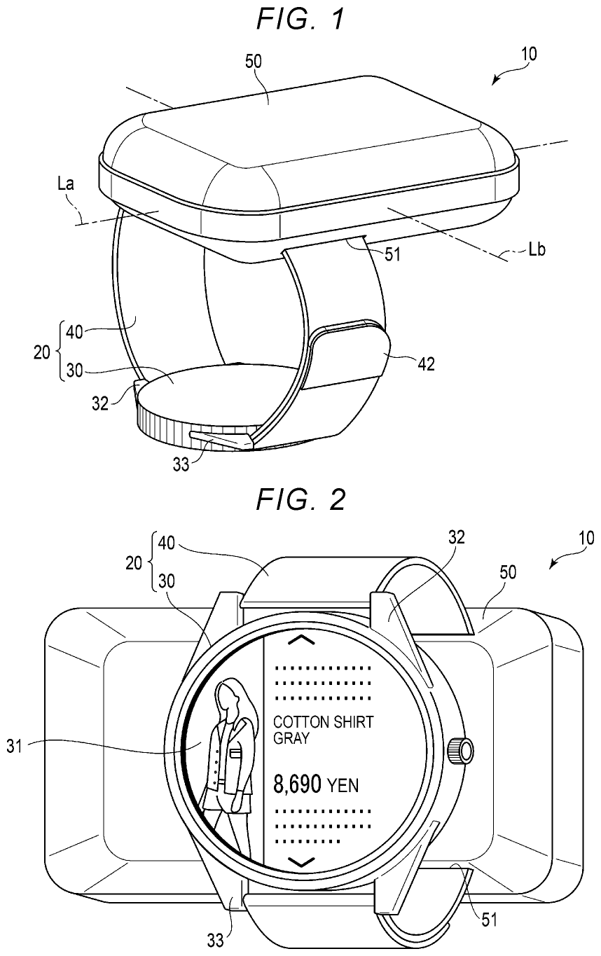

FIGS. 1 to 3 are perspective views illustrating a wearable device 10 according to one embodiment. As illustrated in FIGS. 1 to 3, the wearable device 10 comprises a wristwatch-type device 20 and a sensor device 50 which is attached to the wristwatch-type device 20.

The wristwatch-type device 20 includes a smart device 30 and a band 40 permitting the smart device 30 to be worn on the wrist or lower forearm of a user. In following description, the relational expressions referencing the front and the rear of wearable device 10 or sub-components thereof correspond to the following convention: the side closer to the hand is the front, and the side closer to the elbow is the rear. Similarly, the hand is said to be in front of the wrist, which is front of the forearm, which is in front of the elbow.

The smart device 30 is, in this example, a smart watch. The smart device 30 has various functions such as a date and time display function, a health tracking function, an incoming call notification function, a voice calling function, an information communication function, and a music playback function.

The smart device 30 has a display unit 31 that displays information to the user as text, icons, symbols, pictures, or the like. For example, the display unit 31 comprises a touch screen and is a liquid crystal display (LCD) screen or the like. In this example, the display unit 31 functions as both an input and an output device for information. The smart device 30 incorporates a microcomputer that executes the processing associated with the display information on the display unit 31 and the receiving of information via the display unit 31. The microcomputer also cooperates with the required devices to perform the various functions described above.

The smart device 30 has a pair of attachment portions 32 and 33 for attaching the band 40. Each of the attachment portions 32 and 33 includes a pair of protrusions and a pin supported by the pair of protrusions.

In the present embodiment, one end portion of the band 40 is connected to the attachment portion 32 by the pin of the attachment portion 32. For example, the band 40 is provided with a through hole at the end portion which is connected to the attachment portion 32 by passing the pin through the through hole.

The band 40 is similarly attached by a pin of the attachment portion 33. The band 40 is provided with a fastener 42, and thus, the band 40 can be fastened to a desired position.

The sensor device 50 has a function of reading information by wireless communication. For example, the sensor device 50 is an RFID reader. That is, the sensor device 50 can read the information that has been written in an RFID tag. The sensor device 50 may also be able to write information into an RFID tag. The sensor device 50 transmits the information read from the RFID tag to the smart device 30 by wireless communication.

The sensor device 50 has a substantially rectangular parallelepiped external shape. In this context, a substantially rectangular parallelepiped shape refers to a solid body having six faces corresponding to the six planes of the rectangular parallelepiped, however, these faces of the solid body do not necessarily have to be within a plane surface, but some or all may be curved surfaces or incorporate curved surfaces.

The surface of the sensor device 50 that is facing the forearm when the wearable device 10 is being worn is referred to as the bottom surface of the sensor device 50, and the opposite surface is referred to as the top surface. In addition to the bottom surface and the top surface, the sensor device 50 has two pairs of side surfaces facing each other. As illustrated in FIG. 1, an axial line La passes through the center of the one pair of side surfaces and an axial line Lb passes through the center of the other pair of side surfaces. The axial line La and the axial line Lb are perpendicular or substantially perpendicular to each other.

In the sensor device 50, the dimension along the axial line La is larger than the dimension along the axial line Lb. The axial line La is also referred to as the major axial line La, and the axial line Lb is also referred to as the minor axial line Lb.

The sensor device 50 is attached to the band 40 so as to be located on the opposite side of the arm from the smart device 30 during the wearing of the wearable device 10. The sensor device 50 is attached to the wristwatch-type device 20 so that the minor axial line Lb is corresponds to the wrapping direction of the band 40.

The sensor device 50 is larger in dimension than the smart device 30 at least along a direction parallel to the axial line La. For example, the dimension of the sensor device 50 along the axial line La is larger than the dimension of the smart device 30 parallel to the axial line La. The dimension of the sensor device 50 along the axial line Lb may also be larger than the dimension of the smart device 30 parallel to the axial line Lb.

The sensor device 50 has an attachment portion 51 by which the sensor device 50 is mounted on the band 40. For example, the attachment portion 51 is an elongated through hole through which the band 40 is passed. The through hole extends along the minor axial line Lb through the sensor device 50.

However, the configuration of the attachment portion 51 is not limited thereto. The attachment portion 51 may have any configuration as long as the sensor device 50 can be attached to the band 40. For example, the attachment portion 51 may be a pair of U-shaped pins fixed to the sensor device 50. In such an example, the band 40 would be passed through the gap between the sensor device 50 and the U-shaped pin.

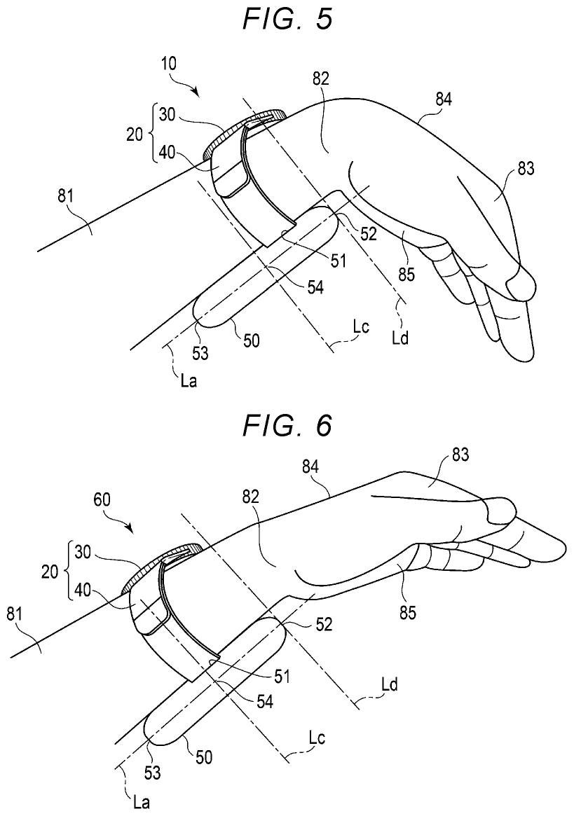

FIGS. 4 and 5 are views illustrating the wearable device 10 being worn. FIG. 4 depicts a state in which a hand 83 is outstretched. FIG. 5 depicts a state in which the hand 83 is bent downward, that is, a state in which the joint of a wrist 82 is bent and a palm 85 faces rearward (towards the user's body). As illustrated in FIGS. 4 and 5, the wearable device 10 is worn on the front end portion of the forearm 81 of the left arm of the user. In this wearing example, the wearable device 10 is worn with the smart device 30 on the same side as the back 84 of the hand 83 and the sensor device 50 on the same side as palm 85.

The wearing orientation of the wearable device 10 can be set according to the orientation of the display unit 31 of the smart device 30. That is, the wearable device 10 is worn so that the top screen position of the display unit 31 is on the same side as the little finger of the hand 83.

The position of the attachment portion 51 of the sensor device 50 during wear will be described. For purposes of explanation, when wearable device 10 is being worn, the first end portion disposed on the side of the hand 83 is referred to as a front end portion 52 and the second end portion disposed on the side of the elbow is referred to as a rear end portion 53. In addition, a central position (midpoint) between the front end portion 52 and the rear end portion 53 is referred to as an intermediate position 54. The distance along the major axial line La from the front end portion 52 to the intermediate position 54 is the same as the distance along the major axial line La from the rear end portion 53 to the intermediate position 54.

In addition, in FIGS. 4 and 5, a straight line Lc passing through the intersection of the intermediate position 54 and the major axial line La and a straight line Ld passing through the intersection of the front end portion 52 and the major axial line La are illustrated. Both the straight line Lc and the straight line Ld are perpendicular or substantially perpendicular to the major axial line La and the minor axial line Lb (refer to FIG. 1).

The attachment portion 51 of the sensor device 50 is offset toward the front end portion 52 from the intermediate position 54. That is, with respect to the position along the major axial line La, the center of the attachment portion 51 is deviated from the intermediate position 54 toward the front end portion 52. For example, as illustrated in FIGS. 4 and 5, the attachment portion 51 is located toward the front end portion 52 offset from the straight line Lc. For example, the entire attachment portion 51 is located between the straight line Lc and the straight line Ld.

The front end portion 52 of the sensor device 50 is not located beyond the front of the smart device 30. In other words, the straight line Ld passing through the front end portion 52 crosses the smart device 30 or touches the front end portion of the smart device 30.

As illustrated in FIG. 5, due to such a disposition of the attachment portion 51, even when the hand 83 is bent (that is, if the joint of the wrist 82 is bent toward the palm 85), the hand 83 does not hit the sensor device 50. That is, the sensor device 50 does not interfere with the work or movement of the user.

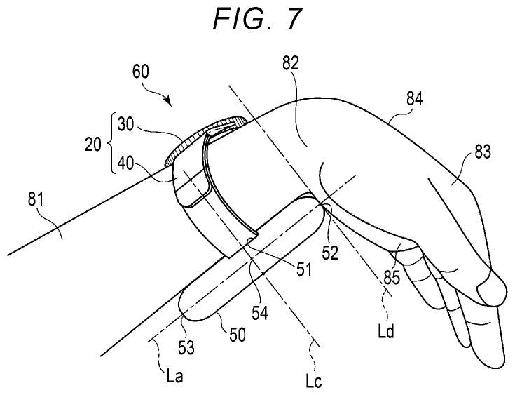

A wearable device 60 according to a Comparative Example will be described with reference to FIGS. 6 and 7. FIGS. 6 and 7 are views illustrating the wearable device 60 according to Comparative Example being worn. FIGS. 6 and 7 depict approximately the same state of the hand 83 as depicted in FIGS. 4 and 5, respectively.

The wearable device 60 is similar to wearable device 10, except that the position of the attachment portion 51 of the sensor device 50 is different.

That is, the wearable device 60 includes a wristwatch-type device 20 and a sensor device 50. However, the attachment portion 51 of the sensor device 50 is provided at the intermediate position 54. That is, the center of the attachment portion 51 is located at the intermediate position 54. In other words, the attachment portion 51 is provided at a position where the straight line Lc passing through the intermediate position 54 crosses the center of the attachment portion 51.

With such a disposition of the attachment portion 51, if the hand 83 is bent as illustrated in FIG. 7, that is, if the joint of the wrist 82 is bent toward the palm 85, the hand 83 hits the sensor device 50. There is a possibility that the sensor device 50 may affect the work or movement of the user.

Hereinafter, one possible use example of the wearable device 10 in an apparel store will be described. In this use example, the user is a clerk of the apparel store, and the sensor device 50 is an RFID reader. With respect to the product such as clothing, an RF tag on which information on the product is written is attached to the product before the product stocking or display.

At the time of stocking or displaying a tagged product at a store, the product is carried by hand of a clerk wearing the wearable device 10. At that time, the sensor device 50 reads the information of the product from the RF tag attached to the product.

The sensor device 50, which is an RFID reader in this example, can read information from a plurality of products at the same time. Since the sensor device 50 can have a wide reading range, the clerk does not necessarily have to search for the RF tag(s) on each product to read the tag information. That is, the clerk can read the information of a plurality of products with the sensor device 50 without the trouble of physically attempting to acquire the information the tag information by, for example, searching for a tag or label with a barcode or the like thereon.

The sensor device 50 also transmits the read information to the smart device 30 by wireless communication. The smart device 30 stores the received information. The smart device 30 can display the requested information in response to a request.

The clerk who is wearing the wearable device 10 can also operate the smart device 30 in response to a question or the like from a customer who is interested in a certain product, and as illustrated in FIG. 2, the clerk can display the information on the product on the display unit 31 of the smart device 30. For example, the information displayed on the display unit 31 includes image information and text information. The text information includes information such as a product name, a price, product materials, product functions, a design concept, care tips, and advice for when wearing the corresponding apparel, and the like.

Accordingly, the clerk can quickly provide the customer with the accurate information on the product without searching for a tag or the like.

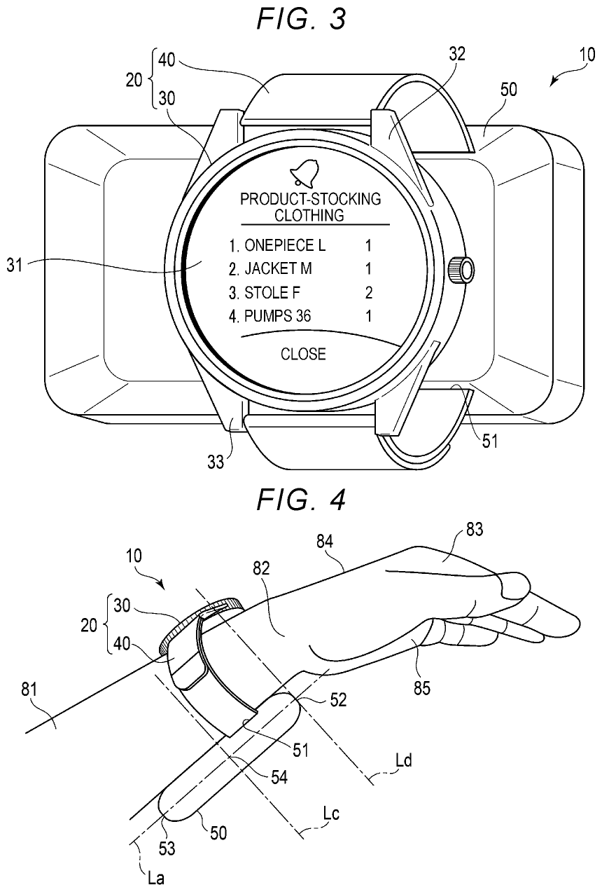

In addition, the clerk can request the wearable device 10 to display the information about the products to be product-stocked next. In response to such a request, the sensor device 50 reads the information about previously sold products from a register system or the like by wireless communication and transmits the information to the smart device 30. As illustrated in FIG. 3, the smart device 30 displays the information on the products to be stocked next (e.g., the products to be placed on store shelves or display for purchase) on the display unit 31 based on the received information.

Accordingly, the clerk can quickly obtain the information on the products to be stocked next. This contributes to improving the work efficiency of product stocking and to reducing mistakes in product stocking.

According to an embodiment, a sensor device 50 that can be used to extend the functions or used of a wristwatch-type device 20 without impairing the movement of the wearer (user) is described. The wearable device 10 can provide functions of the smart device 30 as well as additional functions enabled or implemented by the sensor device 50. That is, in some examples, the sensor device 50 can work in cooperation with the smart device 30.

In an example the wearable device 10 is worn on the front end portion of the forearm 81 with the smart device 30 on the side of the back 84 of the hand 83 and the sensor device 50 on the side of the palm 85. However, the method of wearing the wearable device 10 is not limited thereto. The wearable device 10 may be worn on the front end portion of the forearm 81 with the smart device 30 on the side of the palm 85 and the sensor device 50 on the side of the back 84 of the hand 83.

Even with such wearing arrangement, the hand 83 does not hit the sensor device 50 even though the hand 83 is dorsiflexed, that is, even though the joint of the wrist 82 is bent toward the back 84 of the hand 83. That is, the sensor device 50 does not interfere with the work or full movement of the user's hand.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sensor device for a wearable device with a smart device and a band enabling the smart device to be worn on a forearm of a user, the sensor device comprising:
a first end portion nearer the hand of a user when the wearable device is worn on the forearm of the user;
a second end portion nearer the elbow of the user when the wearable device is worn on the forearm of the user; and
an attachment portion configured to connect to the band, the attachment portion being offset from a midpoint between the first end portion and the second end portion along a direction along the forearm from the elbow to the hand towards the first end portion.

2. The sensor device according to claim 1, wherein the sensor device is a radio frequency identification (RFID) tag reader.

3. The sensor device according to claim 2, wherein the attachment portion is a through-hole permitting the band to pass through a housing of the sensor device.

4. The sensor device according to claim 3, wherein the housing is a rectangular parallelepiped shape.

5. The sensor device according to claim 4, wherein the rectangular parallelepiped shape has rounded corners.

6. The sensor device according to claim 4, wherein the housing is longer in the direction along the forearm from the elbow toward the hand than in a direction that is perpendicular to the direction along the forearm from the elbow toward the hand.

7. The sensor device according to claim 1, wherein the attachment portion is a through-hole permitting the band to pass through a housing of the sensor device.

8. The sensor device according to claim 7, wherein the housing is a rectangular parallelepiped shape.

9. The sensor device according to claim 7, wherein the housing has rounded corners.

10. A wearable electronic device, comprising:
a smart terminal device;
a band enabling the smart terminal device to be worn on a forearm of a user; and
a sensor device attached to the band and including:
a first end portion nearer the hand of the user when the wearable device is worn on the forearm;
a second end portion nearer the elbow of the user when the wearable device is worn on the forearm; and
an attachment portion connecting to the band, the attachment portion being offset from a midpoint between the first end portion and the second end portion along a direction along the forearm from the elbow to the hand towards the first end portion.

11. The wearable electronic device according to claim 10, wherein the sensor device and the smart terminal device are on opposite sides of the forearm when the smart terminal device is worn on the forearm.

12. The wearable electronic device according to claim 10, wherein the sensor device is a radio frequency identification (RFID) reader.

13. The wearable electronic device according to claim 12, wherein the smart device is a smart watch.

14. The wearable electronic device according to claim 10, wherein the smart device is a smart watch.

15. The wearable electronic device according to claim 10, wherein the attachment portion is a through-hole permitting the band to pass through a housing of the sensor device.

16. The wearable electronic device according to claim 15, wherein the housing is a rectangular parallelepiped shape.

17. The wearable electronic device according to claim 16, wherein the rectangular parallelepiped shape has rounded corners.

18. A sensor device to be attached to a band of a smart watch, the sensor device comprising:
a housing including a through hole permitting a band of a smart watch to pass therethrough, the housing having:
a first end portion nearer the hand of a user when the smart watch is worn on a forearm of a user;
a second end portion nearer the elbow of the user when the smart watch is worn on the forearm of the user, wherein
the through hole is offset from a midpoint between the first end portion and the second end portion of the housing along a direction along the forearm from the elbow to the hand towards the first end portion.

19. The sensor device according to claim 18, wherein the sensor device is a radio frequency identification (RFID) reader.

20. The sensor device according to claim 18, wherein
the housing is a rectangular parallelepiped with rounded corners, and
the housing is longer in the direction along the forearm from the elbow toward the hand than in a direction that is perpendicular to the direction along the forearm from the elbow toward the hand.
